(19) United States
(12) Patent Application Publication
(10) Pub. No.: US 2014/0177302 A1
(43) Pub. Date: Jun. 26, 2014

(54) POWER FACTOR CORRECTION APPARATUS AND POWER SUPPLY APPARATUS

(71) Applicant: SAMSUNG ELECTRO-MECHANICS CO., LTD., Suwon (KR)

(72) Inventors: Joon Youp SUNG, Suwon (KR); Jung Sun KWON, Suwon (KR); Seo Hyung KIM, Suwon (KR); Jae Shin LEE, Suwon (KR)

(73) Assignee: SAMSUNG ELECTRO-MECHANICS CO., LTD.

(21) Appl. No.: 13/931,598

(22) Filed: Jun. 28, 2013

(30) Foreign Application Priority Data
Dec. 21, 2012 (KR) 10-2012-0151008

(51) Int. Cl. H02M 1/42; G05F 1/46

(52) U.S. Cl. CPC H02M 1/42; G05F 1/46
USPC 363/89; 323/282; 323/205

(57) ABSTRACT

There are provided a power factor correction apparatus and a power supply apparatus, the power supply apparatus including a power supply unit switching input power to supply preset driving power to a load, and a control unit providing a switching control signal having a preset number of pulses for a predetermined time to the power supply unit to control power switching of the power supply unit, and when a voltage level of the driving power is equal to or higher than that of at least one intermediate voltage set between a preset normal operating voltage and a preset abnormal operating voltage, skipping a portion of the number of pulses of the switching control signal for the predetermined time.

### CROSS-REFERENCE TO RELATED APPLICATIONS

This application claims the priority of Korean Patent Application No. 10-2012-0151008 filed on Dec. 21, 2012, in the Korean Intellectual Property Office, the disclosure of which is incorporated herein by reference.

### BACKGROUND OF THE INVENTION

1. Field of the Invention

The present invention relates to a power factor correction apparatus and a power supply apparatus having an overvoltage protection function.

2. Description of the Related Art

Generally, various types of electronic devices meeting various user requirements have been implemented. Such electronic devices may adopt a power supply apparatus supplying driving power so as to implement corresponding functions.

The power supply apparatus may generally adopt a switching mode power supply method that has advantages of power conversion efficiency, miniaturization, and the like.

Meanwhile, most power supply apparatuses generally adopt an overvoltage protection circuit so as to prevent damage to or malfunctioning of circuits due to an output overvoltage due to abnormal operating of a power supply circuit or abnormal external environments.

The overvoltage protection circuit detects whether an overvoltage is supplied to loads and if so, cut-off the supply of power to loads.

For this reason, similar to the invention disclosed in the following prior art, the overvoltage protection circuit controls a switching-on time of a switching element performing a power conversion operation to cut-off the supply of power to loads at the time of the occurrence of an overvoltage.

However, as described above, the overvoltage protection method of controlling the switching-on time of the switching element and cutting off the supply of power to loads performs a normal switching operation even when the output power is instantaneously increased to an overvoltage level and maintains the supply of power for a predetermined time, even at the time of cutting-off the supply of power to loads, making it difficult to immediately prevent damage or malfunctioning of circuits.

### RELATED ART DOCUMENT

[Patent Document]
(Patent Document 1) Korean Patent Laid-Open Publication No. 10-2000-0044338

### SUMMARY OF THE INVENTION

An aspect of the present invention provides a power factor correction apparatus and a power supply apparatus having an overvoltage protection function capable of protecting a circuit immediately at the time that an overvoltage occurs, by skipping a gate signal applied to a switching element at the time of detecting an intermediate voltage having a level between a normal voltage level and an overvoltage level.

According to an aspect of the present invention, there is provided a power supply apparatus, including: a power supply unit switching input power to supply preset driving power to a load; and a control unit providing a switching control signal having a preset number of pulses for a predetermined time to the power supply unit to control power switching of the power supply unit, and when a voltage level of the driving power is equal to or higher than that of at least one intermediate voltage set between a preset normal operating voltage and a preset abnormal operating voltage, skipping a portion of the number of pulses of the switching control signal for the predetermined time.

The control unit may skip all the pulses of the switching control signal for the predetermined time when the voltage level of the driving power corresponds to that of the abnormal operating voltage.

The intermediate voltage may be set to have a plurality of voltage levels between the normal operating voltage and the abnormal operating voltage, and the control unit may increase the number of skipped pulses among the number of the pulses of the switching control signal for the predetermined time in response to an increase in the voltage level of the intermediate voltage when the voltage level of the driving power corresponds to one of the plurality of voltages levels of the intermediate voltage.

The control unit may include: an overvoltage detector detecting whether the voltage level of the driving power corresponds to that of the abnormal operating voltage; a current detector detecting a current flowing in the power switching of the power supply unit; a driver supplying the switching control signal based on detected results of the overvoltage detector and the current detector to control the supply of power of the power supply unit; and a pulse skipping unit skipping the number of pulses of the switching control signal supplied by the driver when the voltage level of the driving power corresponds to that of the intermediate voltage.

The pulse skipping unit may include: a first comparator comparing whether the voltage level of the driving power corresponds to that of the intermediate voltage; a clock generator generating a clock signal based on a compared result of the first comparator; an AND unit performing a logical product operation on the clock signal of the clock generator and a preset timing; a signal generator generating a sawtooth wave signal according to a logical product operation result of the AND unit; a second comparator comparing a voltage level of a preset reference voltage with the voltage level of the driving power; and a third comparator comparing a comparison result signal of the second comparator with the sawtooth wave signal to provide a compared result to the driver.

According to another aspect of the present invention, there is provided a power factor correction apparatus, including: a power factor correction unit switching input power and controlling a phase difference between a voltage and a current of the input power to correct a power factor thereof; and a control unit providing a switching control signal having a preset number of pulses for a predetermined time to the power supply unit to control power switching of the power factor correction unit, and when a voltage level of output power of the power factor correction unit is equal to or higher than that of at least one intermediate voltage set between a preset normal operating voltage and a preset abnormal operating voltage, skipping a portion of the number of pulses of the switching control signal for the predetermined time.

The control unit may skip all the pulses of the switching control signal for the predetermined time when the voltage level of the output power corresponds to the abnormal operating voltage.

The intermediate voltage may be set to have a plurality of voltage levels between the normal operating voltage and the abnormal operating voltage, and the control unit may increase the number of skipped pulses among the number of pulses of the switching control signal for the predetermined time in response to an increase in the voltage level of the intermediate voltage when the voltage level of the output power corresponds to one of the plurality of voltages levels of the intermediate voltage.

The control unit may include: an overvoltage detector detecting whether the voltage level of the output power corresponds to the abnormal operating voltage; a current detector detecting a current flowing in the power switching of the power supply unit; a driver supplying the switching control signal based on detected results of the overvoltage detector and the current detector to control the power switching of the power factor correction unit; and a pulse skipping unit skipping the number of pulses of the switching control signal supplied by the driver when the voltage level of the output power corresponds to that of the intermediate voltage.

The pulse skipping unit may include: a first comparator comparing whether the voltage level of the output power corresponds to that of the intermediate voltage; a clock generator generating a clock signal based on a compared result of the first comparator; an AND unit performing a logical product operation on the clock signal of the clock generator and a preset timing; a signal generator generating a sawtooth wave signal according to a logical product operation result of the AND unit; a second comparator comparing a voltage level a preset reference voltage with the voltage level of the output power; and a third comparator comparing a comparison result signal of the second comparator with the sawtooth wave signal to provide a comparison result to the driver.

The power factor correction apparatus may further include: a rectification unit rectifying AC power and providing the rectified AC power to the power factor correction unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram schematically illustrating a power supply apparatus according to an embodiment of the present invention;

FIG. 2 is a configuration diagram schematically illustrating a power factor correction apparatus according to an embodiment of the present invention; and

FIGS. 3 and 4 are graphs illustrating an overvoltage protection operation of a control unit employed in the power supply apparatus or the power factor correction apparatus according to the embodiment of the present invention.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

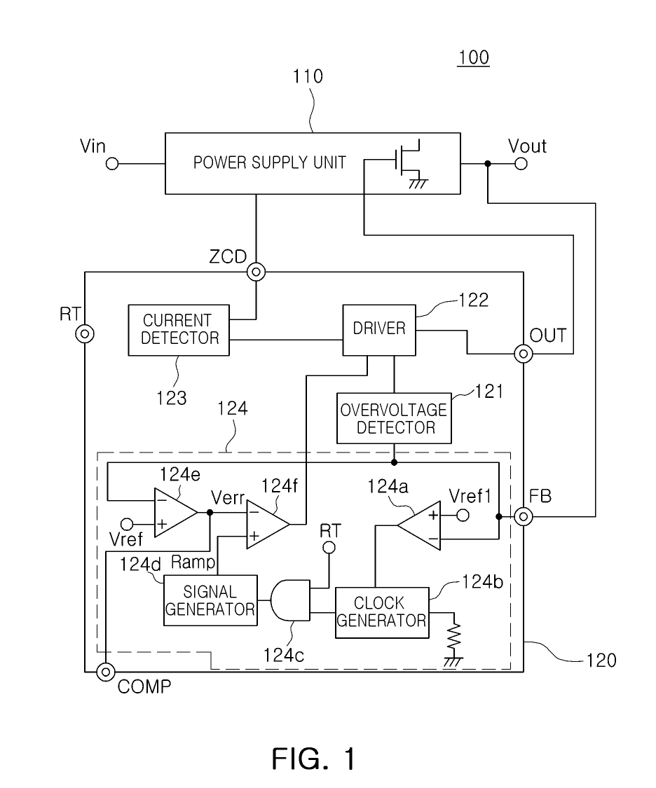

FIG. 1 is a configuration diagram schematically illustrating a power supply apparatus according to an embodiment of the present invention.

Referring to FIG. 1, a power supply apparatus 100 according to an embodiment of the present invention may include a power supply unit 110 and a control unit 120.

The power supply unit 110 may switch an input power Vin to supply driving power Vout to a load. The power switching of the power supply unit 110 may be performed according to a control of the control unit 120.

The control unit 120 may supply a switching control signal OUT to the power supply unit 110 to control the power switching of the power supply unit 110.

To this end, the switching control signal OUT may contain a preset number of pulses for a predetermined time and a switch of the power supply unit 110 may perform a switching-on operation according to a high level of the pulse and may perform a switching-off operation according to a low level of the pulse.

The control unit 120 may include an overvoltage detector 121, a driver 122, a current detector 123, and a pulse skipping unit 124.

The overvoltage detector 121 may compare a level of a feedback voltage FB obtained by detecting the driving power Vout of the power supply unit 110 with an abnormal operating voltage having a preset voltage level, and if it is determined that the level of the feedback voltage FB corresponds to the level of the abnormal operating voltage, may stop the supply of the switching control signal OUT of the driver 122 to apply a low level signal to the switch of the power supply unit 110.

The current detector 123 may detect a current flowing in the switch, in more detail, a zero (0) current flowing in the switch, by the switching operation of the power supply unit 110.

The driver 122 may apply the switching control signal OUT to the switch of the power supply unit 110 according to results of the detection of the overvoltage detector 121 and the current detector 123.

Meanwhile, the pulse skipping unit 124 may skip at least a portion of the pulses of the switching control signal OUT from the driver 122 for a predetermined time.

For this purpose, the pulse skipping unit 124 may include a first comparator 124a, a clock generator 124b, an AND unit 124c, a signal generator 124d, a second comparator 124e, and a third comparator 124f.

The first comparator 124a compares the level of the feedback voltage FB with a level of an intermediate voltage Vref1 set between the preset normal operating voltage and the abnormal operating voltage and provides the compared result to the clock generator 124b.

If the level of the feedback voltage FB is less than that of the intermediate voltage Vref1, the first comparator 124a may output a high level signal and if the feedback voltage FB level is equal to or higher than that of the intermediate voltage Vref1, may output a low level signal.

The clock generator 124b may provide preset clock signals and time intervals between the clock signals may be used to skip the pulses of the switching control signal OUT.

That is, if the output of the first comparator 124a is the high level signal, the clock generator 124b may output a signal maintained at a high level and if the output of the first comparator 124a is the low level signal, may output a clock signal having a preset time interval.

The AND unit 124c may perform a logical product operation on an externally set timing signal RT and the output signal of the clock generator 124b and provide an operation result to the signal generator 124d. The logical product operation on the timing signal RT and the output signal of the clock generator 124b may allow a sawtooth wave signal of the signal generator 124d to be discontinuously generated according to the time intervals of the clock signals of the clock generator 124b. That is, the sawtooth wave signal may be skipped at the time intervals.

The time intervals of the clock generator 124b may be determined by a resistance value of a resistor electrically connected to the clock generator 124b.

Meanwhile, the second comparator 124e may compare a level of a preset reference voltage Vref with the level of the feedback voltage FB to control that the level of the feedback voltage FB is maintained as that of the reference voltage Vref.

The third comparator 124f may compare a sawtooth wave signal Ramp from the signal generator 124d with a comparison result signal from the second comparator 124e and transfer the compared result to the driver 122.

In more detail, when the level of the feedback voltage FB is lower than that of the reference voltage Vref, the level of an output signal Verr is increased, and thus an on-time of the switching control signal OUT provided from the driver 122 is increased, such that the level of the driving power Vout of the power supply unit 110 is increased.

To the contrary, when the level of the feedback voltage FB is higher than that of the reference voltage Vref, the level of the output signal Verr is reduced, and thus the on-time of the switching control signal OUT provided from the driver 122 is reduced, such that the level of the driving power Vout of the power supply unit 110 is reduced.

The foregoing operation may be repeated, such that the level of the feedback voltage FB is maintained as the level of the reference voltage Vref.

That is, when the power supply apparatus 100 is normally operated, the voltage level of the driving power Vout of the power supply unit 110 may be controlled to be maintained as the level of the reference voltage Vref, but when the voltage level of the driving power Vout is increased to the level of the abnormal operating voltage due to abnormal operations of a power circuit or external abnormal environments, the switching control signal OUT of the control unit 120 is maintained at a low level to stop the power switching operation of the power supply unit 110.

In this case, when the voltage level of the driving power Vout of the power supply unit 110 corresponds to that of the intermediate voltage Vref1 set between the normal operating voltage Vref and the abnormal operating voltage, the sawtooth wave signal of the signal generator 124b is intermittently generated according to the time intervals of the clock signals generated from the clock generator 124b, such that the number of pulses of the switching control signal OUT applied from the driver 122 may be skipped, thereby suppressing an increase in the voltage level of the driving power Vout of the power supply unit 110.

Meanwhile, as a type of power supply apparatus according to the embodiment of the present invention a power factor correction apparatus may be provided.

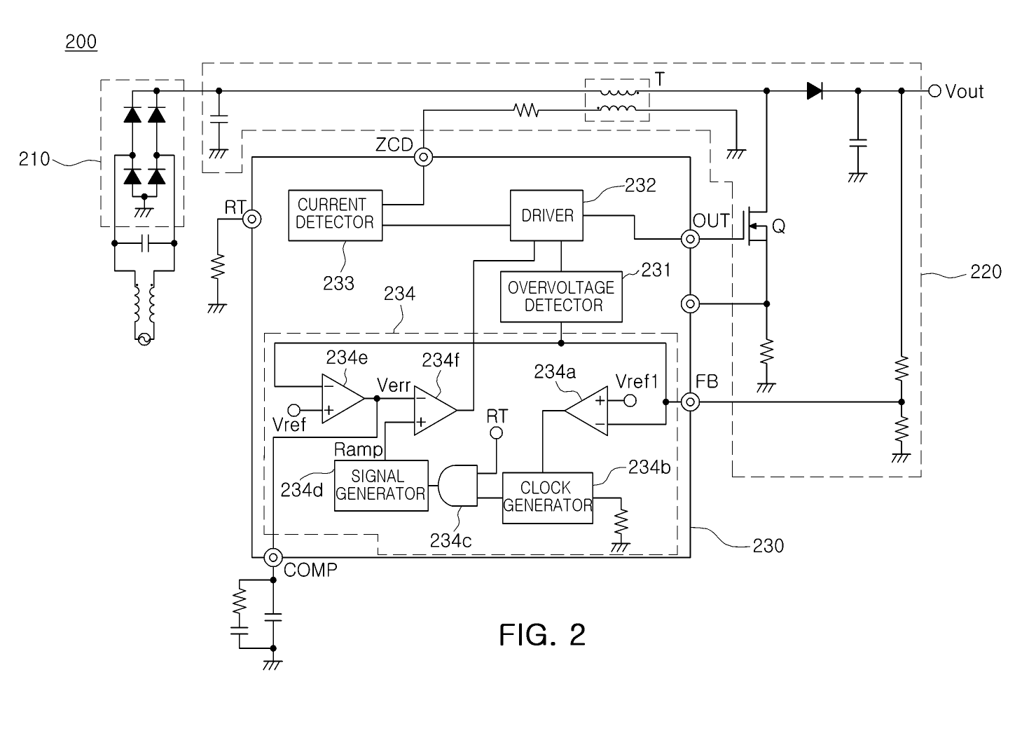

FIG. 2 is a configuration diagram schematically illustrating a power factor correction apparatus according to an embodiment of the present invention.

Referring to FIG. 2, a power factor correction apparatus 200 according to the embodiment of the present invention may include a rectification unit 210, a power factor correction unit 220, and a control unit 230.

The rectification unit 210 rectifies input AC power and transfers the rectified AC power to the power factor correction unit 220, and the power factor correction unit 220 switches the rectified AC power into DC power and controls a phase difference between a voltage and a current of the DC power to correct a power factor thereof.

The control unit 230 controls that the voltage level of the output power Vout is maintained as the normal operating voltage Vref based on the feedback voltage FB obtained by detecting the output power Vout of which the power factor is corrected by the power factor correction unit 220, and when the output power Vout corresponds to the abnormal operating voltage, maintains the switching control signal OUT controlling switching of a switch Q at the low level to thereby stop the power switching operation of the power factor correction unit 220.

In this case, when the voltage level of the output power Vout of the power factor correction unit 220 corresponds the level of an intermediate voltage Vref1 set between the normal operating voltage Vref and the abnormal operating voltage, the control unit 230 may skip a portion of the pulses of the switching control signal OUT to control an increase in the voltage level of the output power Vout.

An overvoltage detector 231, a driver 232, a current detector 233 detecting a current from a transformer T of the power factor correction unit 220, and a pulse skipping unit 234 of the control unit 230 have operations and functions similar to those of the overvoltage detector 121, the driver 122, the current detector 123, and the pulse skipping unit 124 as illustrated in FIG. 1 and therefore a detailed description thereof will be omitted. FIG. 2 illustrates that the current detector 233 detects the current from the transformer T of the power factor correction unit 220, however it may be apparent that a method of detecting a current using a resistor may be used to detect the current generally flowing in a circuit, and therefore the embodiment of the present invention is not limited thereto.

Similarly, a first comparator 234a, a clock generator 234b, an AND unit 234c, a signal generator 234d, a second comparator 234e, and a third comparator 234f of the pulse skipping unit 234 have the same operations and functions similar to those of the first comparator 124a, the clock generator 124b, the AND unit 124c, the signal generator 124d, the second comparator 124e, and the third comparator 124f of the pulse skipping unit as illustrated in FIG. 1, and a detailed description thereof will be omitted.

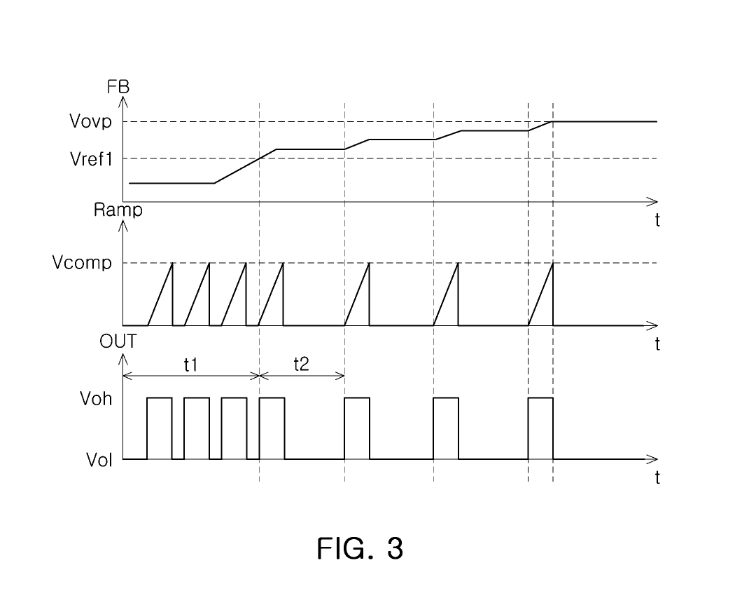

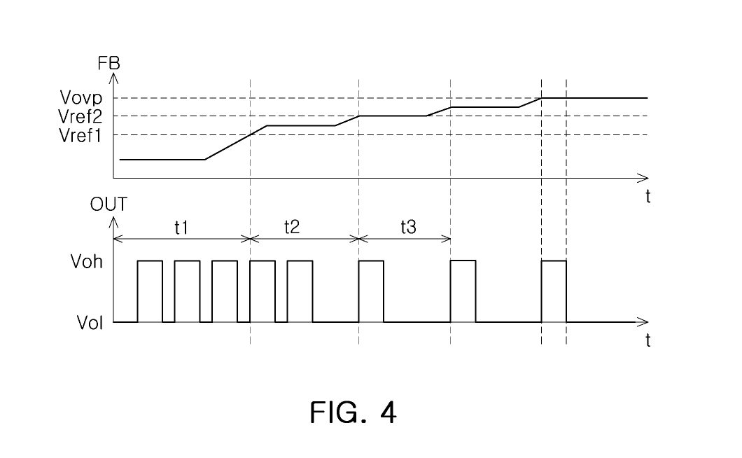

FIGS. 3 and 4 are graphs illustrating an overvoltage protection operation of the control unit employed in the power supply apparatus or the power factor correction apparatus according to the embodiment of the present invention.

Referring to FIG. 3, as illustrated in FIGS. 1 and 2, when the voltage level of the driving power or the output power Vout from the power supply unit 110 or the power factor correction unit 220 is increased higher than that of the normal operating voltage Vref by the control units 120 and 230 and corresponds to the intermediate voltage Vref1, a portion of the pulses (refer to t1) of the switching control signal supplied for a predetermined time is skipped (refer to t2) to suppress the increase in the voltage level of the driving power or the output power Vout, and when the voltage level of the driving power or the output power Vout corresponds to that of the abnormal operating voltage Vovp, all the pulses of the switching control signal are skipped to set the level of the switching control signal to be a low level so as to stop the switching operation of the power supply unit 110 or the power factor correction unit 220, thereby immediately suppressing the increase in voltage level.

Meanwhile, as illustrated in FIG. 4, the intermediate voltage may be set to have a plurality of voltage levels, for example, a first intermediate voltage Vref1 and a second intermediate voltage Vref2 and if the level of the driving power or the output power Vout from the power supply unit 110 or the power factor correction unit 220 may correspond to a level of the first intermediate voltage Vref1 or the second intermediate voltage Vref2, when a portion of the pulses (refer to t1) of the switching control signal for a predetermined time, that is, the number of pulses of the switching control signal supplied for a predetermined time is, for example, 3, a method of suppressing the increase in the voltage level of the driving power or the output power Vout by skipping only one pulse (refer to t2) in the case of the first intermediate voltage Vref1 and skipping two pulses (refer to t3) in the case of the second intermediate voltage Vref2 may be selected.

As set forth above, according to the embodiments of the present invention, a circuit can be protected immediately at the time that an overvoltage occurs, by skipping a gate signal applied to a switching element at the time of detecting an intermediate voltage having a level between a normal voltage level and an overvoltage level.

While the present invention has been shown and described in connection with the embodiments, it will be apparent to those skilled in the art that modifications and variations can be made without departing from the spirit and scope of the invention as defined by the appended claims.

What is claimed is:

1. A power supply apparatus, comprising:
a power supply unit switching input power to supply preset driving power to a load; and
a control unit providing a switching control signal having a preset number of pulses for a predetermined time to the power supply unit to control power switching of the power supply unit, and when a voltage level of the driving power is equal to or higher than that of at least one intermediate voltage set between a preset normal operating voltage and a preset abnormal operating voltage, skipping a portion of the number of pulses of the switching control signal for the predetermined time.

2. The power supply apparatus of claim 1, wherein the control unit skips all the pulses of the switching control signal for the predetermined time when the voltage level of the driving power corresponds to that of the abnormal operating voltage.

3. The power supply apparatus of claim 1, wherein the intermediate voltage is set to have a plurality of voltage levels between the normal operating voltage and the abnormal operating voltage, and
the control unit increases the number of skipped pulses among the number of the pulses of the switching control signal for the predetermined time in response to an increase in the voltage level of the intermediate voltage when the voltage level of the driving power corresponds to one of the plurality of voltages levels of the intermediate voltage.

4. The power supply apparatus of claim 1, wherein the control unit includes:
an overvoltage detector detecting whether the voltage level of the driving power corresponds to that of the abnormal operating voltage;
a current detector detecting a current flowing in the power switching of the power supply unit;
a driver supplying the switching control signal based on detected results of the overvoltage detector and the current detector to control the supply of power of the power supply unit; and
a pulse skipping unit skipping the number of pulses of the switching control signal supplied by the driver when the voltage level of the driving power corresponds to that of the intermediate voltage.

5. The power supply apparatus of claim 4, wherein the pulse skipping unit includes:
a first comparator comparing whether the voltage level of the driving power corresponds to that of the intermediate voltage;
a clock generator generating a clock signal based on a compared result of the first comparator;
an AND unit performing a logical product operation on the clock signal of the clock generator and a preset timing;
a signal generator generating a sawtooth wave signal according to a logical product operation result of the AND unit;
a second comparator comparing a voltage level of a preset reference voltage with the voltage level of the driving power; and
a third comparator comparing a comparison result signal of the second comparator with the sawtooth wave signal to provide a compared result to the driver.

6. A power factor correction apparatus, comprising:
a power factor correction unit switching input power and controlling a phase difference between a voltage and a current of the input power to correct a power factor thereof; and
a control unit providing a switching control signal having a preset number of pulses for a predetermined time to the power supply unit to control power switching of the power factor correction unit, and when a voltage level of output power of the power factor correction unit is equal to or higher than that of at least one intermediate voltage set between a preset normal operating voltage and a preset abnormal operating voltage, skipping a portion of the number of pulses of the switching control signal for the predetermined time.

7. The power factor correction apparatus of claim 6, wherein the control unit skips all the pulses of the switching control signal for the predetermined time when the voltage level of the output power corresponds to the abnormal operating voltage.

8. The power factor correction apparatus of claim 6, wherein the intermediate voltage is set to have a plurality of voltage levels between the normal operating voltage and the abnormal operating voltage, and
the control unit increases the number of skipped pulses among the number of pulses of the switching control signal for the predetermined time in response to an increase in the voltage level of the intermediate voltage when the voltage level of the output power corresponds to one of the plurality of voltages levels of the intermediate voltage.

9. The power factor correction apparatus of claim 6, wherein the control unit includes:
an overvoltage detector detecting whether the voltage level of the output power corresponds to the abnormal operating voltage;
a current detector detecting a current flowing in the power switching of the power supply unit;
a driver supplying the switching control signal based on detected results of the overvoltage detector and the current detector to control the power switching of the power factor correction unit; and
a pulse skipping unit skipping the number of pulses of the switching control signal supplied by the driver when the voltage level of the output power corresponds to that of the intermediate voltage.

10. The power factor correction apparatus of claim 9, wherein the pulse skipping unit includes:
a first comparator comparing whether the voltage level of the output power corresponds to that of the intermediate voltage;
a clock generator generating a clock signal based on a compared result of the first comparator;
an AND unit performing a logical product operation on the clock signal of the clock generator and a preset timing;
a signal generator generating a sawtooth wave signal according to a logical product operation result of the AND unit;
a second comparator comparing a voltage level a preset reference voltage with the voltage level of the output power; and
a third comparator comparing a comparison result signal of the second comparator with the sawtooth wave signal to provide a comparison result to the driver.

11. The power factor correction apparatus of claim 6, further comprising:
a rectification unit rectifying AC power and providing the rectified AC power to the power factor correction unit.
